(19) United States
(12) Patent Application Publication
(10) Pub. No.: US 2010/0266923 A1
(43) Pub. Date: Oct. 21, 2010

(54) FUEL CELL SYSTEM WITH ELECTROCHEMICAL HYDROGEN PUMP AND METHOD OF OPERATING SAME

(75) Inventors: James F. MCELROY, Suffield, CT (US); Arne Ballantine, Palo Alto, CA (US); K.R. Sridhar, Los Gatos, CA (US); Matthias Gottmann, Sunnyvale, CA (US)

Correspondence Address: FOLEY AND LARDNER LLP;SUITE 500, 3000 K STREET NW, WASHINGTON, DC, 20007, US

(73) Assignee: BLOOM ENERGY CORPORATION

(21) Appl. No.: 12/759,395

(22) Filed: Apr. 13, 2010

Related U.S. Application Data
(60) Provisional application No. 61/202,876, filed on Apr. 15, 2009.

(51) Int. Cl. H01M 8/04

(52) U.S. Cl. 429/444

(57) ABSTRACT

A fuel cell system includes a plurality of fuel cells, a plurality of interconnects, and a hydrogen separation device, wherein the hydrogen separation device separates hydrogen from the fuel cell stack anode exhaust. The separated hydrogen is then reintroduced into the fuel cell stack to optimize overall system efficiency. Monitoring of the performance of the hydrogen separation device gives an indication as to the fuel cell system performance.

### CROSS REFERENCE TO RELATED PATENT APPLICATIONS

The present application claims benefit of U.S. provisional application No. 61/202,876, filed Apr. 15, 2009, which is incorporated herein by reference in its entirety.

### FIELD OF THE INVENTION

The present invention is generally directed to the operation of a fuel cell and more specifically to operation of fuel cell systems that include electrochemical hydrogen pumps.

### BACKGROUND OF THE INVENTION

Fuel cells are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels. There are classes of fuel cells, such as the solid oxide reversible fuel cells, that also allow reversed operation, such that water or other oxidized fuel can be reduced to unoxidized fuel using electrical energy as an input.

In a high temperature fuel cell system such as a solid oxide fuel cell (SOFC) system, an oxidizing flow is passed through the cathode side of the fuel cell while a reducing flow is passed through the anode side of the fuel cell. The oxidizing flow is typically air, while the reducing flow typically comprises a mixture of a hydrogen-rich gas created by reforming a hydrocarbon fuel source and water vapor. The fuel cell, typically operating at a temperature between 750° C. and 950° C., enables the transport of negatively charged oxygen ions from the cathode flow stream to the anode flow stream, where the ions combine with either free hydrogen or hydrogen in a hydrocarbon molecule to form water vapor and/or with carbon monoxide to form carbon dioxide. The excess electrons from the negatively charged ions are routed back to the cathode side of the fuel cell through an electrical circuit completed between anode and cathode, resulting in an electrical current flow through the circuit.

### SUMMARY OF THE INVENTION

Embodiments of a first aspect of the present invention provide methods of operating a fuel cell system that comprises a fuel cell stack and an electrochemical hydrogen pump. The methods comprise: a) providing at least a portion of the fuel cell stack anode exhaust to the electrochemical hydrogen pump; b) separating at least a portion of hydrogen contained in the fuel cell stack anode exhaust stream with the electrochemical hydrogen pump; c) providing at least a portion of the separated hydrogen into the fuel cell stack anode inlet; d) monitoring a potential of the electrochemical hydrogen pump; and e) adjusting a flow of one or more of the fuel cell stack input streams or power output of the system based on the monitoring. The streams may comprise gas and/or liquid streams.

In some embodiments, the electrochemical hydrogen pump comprises a proton exchange membrane or a high temperature proton exchange membrane based on a polybenzimidazole (PBI) membrane and is operated at a steady current. In general, the term “membrane” includes but is not limited to these membranes.

In some embodiments, the electrochemical hydrogen pump is operated such that 95% or more of the hydrogen in the fuel cell stack anode exhaust is pumped to a cathode outlet of the electrochemical hydrogen pump.

In some embodiments, the step of adjusting the flow of one or more fuel cell stack input gases comprises increasing flow of fuel inlet gas to the fuel cell stack upon detection of an increase in the potential of the electrochemical hydrogen pump, or decreasing flow of fuel inlet gas to the fuel cell stack upon detection of a decrease in the potential of the electrochemical hydrogen pump.

In some embodiments, the step of adjusting the power output of the system comprises increasing a fuel cell stack power output based on detection of a decrease in potential of the electrochemical hydrogen pump, or decreasing a fuel cell stack power output based on detection of an increase in the electrochemical hydrogen pump potential.

In some embodiments, operation of the electrochemical hydrogen pump results in transfer of water from the fuel cell stack anode exhaust to the electrochemical hydrogen pump cathode outlet flow.

In some embodiments, the step of providing at least a portion of the separated hydrogen comprises providing at least a portion of the electrochemical hydrogen pump cathode outlet flow into the fuel cell stack anode inlet.

In some embodiments, the method further comprises providing at least a portion of the fuel cell stack anode exhaust flow to the fuel cell stack anode inlet while bypassing the electrochemical hydrogen pump.

In some embodiments, the electrochemical hydrogen pump contains a water-gas shift (WGS) catalyst located upstream of the proton exchange membrane or incorporated into or on the proton exchange membrane

In some embodiments, the method further comprises humidifying the separated hydrogen with a membrane humidifier prior to providing the separated hydrogen into the fuel cell stack anode inlet; wherein the membrane humidifier comprises a first inlet operatively connected to the electrochemical hydrogen pump cathode outlet, a second inlet operably connected to one or more of the electrochemical hydrogen pump anode exhaust and an external water source, and a first outlet operatively connected to the fuel cell stack anode inlet.

In some embodiments, the method further comprising collecting fuel cell stack anode exhaust flow leakage from a leakage collection plenum in the electrochemical hydrogen pump and providing the leakage to the electrochemical hydrogen pump anode exhaust.

In some embodiments, the method further comprises using at least a portion of the fuel cell stack cathode exhaust to heat the electrochemical hydrogen pump.

A second aspect of the present invention is a fuel cell system comprising a fuel cell stack; an electrochemical hydrogen pump; and at least one control device which adjusts at least one of the flow rate of one or more fuel cell input streams and a power output of a fuel cell based on a detected potential of the electrochemical hydrogen pump. In embodiments of this aspect, the fuel cell stack comprises: a plurality of fuel cells; a plurality of interconnects; an anode inlet; a cathode inlet; an anode exhaust outlet; and a cathode exhaust outlet. The electrochemical hydrogen pump comprises: an anode; a cathode; a proton exchange membrane; an inlet; an anode exhaust outlet; and a cathode exhaust outlet. In these embodiments, the fuel cell stack anode exhaust is operatively connected to the electrochemical hydrogen pump inlet, and the electrochemical hydrogen pump cathode outlet is operatively connected to the fuel cell stack anode inlet.

In some embodiments, adjusting the flow of one or more fuel cell stack input gases comprises increasing flow of fuel inlet gas to the fuel cell stack upon detection of an increase in the potential of the electrochemical hydrogen pump, or decreasing flow of fuel inlet gas to the fuel cell stack upon detection of a decrease in the potential of the electrochemical hydrogen pump. In some embodiments, adjusting the power output of the fuel cell system based on a detected potential of the electrochemical hydrogen pump comprises increasing a fuel cell stack power output based on detection of a decrease in potential of the electrochemical hydrogen pump, or decreasing a fuel cell stack power output based on detection of an increase in the electrochemical hydrogen pump potential. In some embodiments, both the flow of one or more fuel cell stack input streams and the power output of a fuel cell stack are adjusted based on a detected potential of the electrochemical hydrogen pump.

In some embodiments, the fuel cell system further comprises a venturi located between the electrochemical hydrogen pump cathode exhaust outlet and the fuel cell stack anode inlet; wherein a downstream flow of the venturi is at a lower pressure than an upstream flow. In some related embodiments, the fuel cell system further comprises a suction line operatively connected to a low pressure throat of the venturi; wherein the suction line is operatively connected to one or more of the fuel cell stack anode exhaust conduit upstream of the electrochemical hydrogen pump and the electrochemical hydrogen pump anode exhaust conduit. In some related embodiments, the fuel cell system further comprises a venturi bypass conduit.

In some embodiments, the fuel cell system further comprises a water-gas shift reaction catalyst which is integrated into or on the proton exchange membrane or located within the electrochemical hydrogen pump upstream of the proton exchange membrane.

In some embodiments, the fuel cell system further comprises a membrane humidifier; wherein the anode exhaust conduit of the fuel cell stack is operatively connected to the electrochemical hydrogen anode pump inlet, and the electrochemical hydrogen pump cathode outlet, membrane humidifier, and fuel cell stack anode inlet are operatively connected such that the electrochemical hydrogen pump cathode outlet flow is humidified prior to being introduced to the fuel cell stack anode inlet. In some related embodiments, the source of water for the membrane humidifier comprises the electrochemical hydrogen pump anode outlet flow. In some related embodiments, the source of water for the membrane humidifier comprises a source external to the fuel cell system.

In some embodiments, the electrochemical hydrogen pump further comprises a membrane/electrode assembly seal separating the proton exchange membrane from an anode or cathode; and leakage from the membrane/electrode assembly seal is collected in a plenum that is operatively connected to the electrochemical hydrogen pump anode outlet.

In some embodiments, the fuel cell system further comprises a fuel cell stack cathode exhaust conduit that heats the electrochemical hydrogen pump with high temperature fuel cell stack cathode exhaust.

In some embodiments, the fuel cell system comprises a fuel cell stack, an electrochemical hydrogen pump, and means for adjusting at least one of the flow rate of one or more fuel cell input streams and a power output of a fuel cell based on a detected potential of the electrochemical hydrogen pump; wherein the fuel cell stack anode exhaust conduit is operatively connected to the electrochemical hydrogen pump inlet, and the electrochemical hydrogen pump cathode outlet is operatively connected to the fuel cell stack anode inlet.

Embodiments of a second aspect provide methods of operating a fuel cell system comprising a fuel cell stack and an electrochemical hydrogen pump, the methods comprising: a) providing at least a portion of the fuel cell stack anode exhaust to the electrochemical hydrogen pump; b) transferring at least a portion of hydrogen and water contained in the fuel cell stack anode exhaust stream from the electrochemical hydrogen pump anode to the electrochemical hydrogen pump cathode; and c) providing at least a portion of the separated hydrogen and water into the fuel cell stack anode inlet; wherein the transfer of hydrogen and the transfer of water from the electrochemical hydrogen pump anode to electrochemical hydrogen pump cathode are independently controlled by controlling fuel utilization rate at the electrochemical hydrogen pump anode.

In some embodiments, the methods further comprise providing at least a portion of electrochemical hydrogen pump cathode exhaust flow to a venturi upstream of the fuel cell stack anode inlet; wherein the flow upstream of the venturi is at a higher pressure than the flow downstream of the venturi. In some related embodiments, the method further comprises providing at least a portion of electrochemical hydrogen pump cathode exhaust flow to a venturi bypass conduit which bypasses the venturi. In some related embodiments, the methods further comprise providing a portion of one or more of the electrochemical hydrogen pump anode exhaust flow and the fuel cell stack anode exhaust to a suction line operatively connected to a low pressure throat of the venturi. In some further related embodiments, the method further comprises adjusting a portion of one or more of the electrochemical hydrogen pump anode exhaust flow and the fuel cell stack anode exhaust provided to the suction line based on a change in the composition of fuel used in the fuel cell stack.

In some embodiments, the method further comprises heating the electrochemical hydrogen pump with at least a portion of the fuel cell stack cathode exhaust.

In some embodiments, a water-gas shift reaction catalyst is integrated into or on a proton exchange membrane of the electrochemical hydrogen pump or located within the electrochemical hydrogen pump upstream of a proton exchange membrane.

In some embodiments, the method further comprises humidifying the fuel cell stack anode inlet flow or the electrochemical hydrogen pump cathode exhaust flow with a membrane humidifier. In related embodiments, the water source for the membrane humidifier comprises the electrochemical hydrogen pump anode exhaust flow. In some embodiments, the water source for the membrane humidifier comprises a water source external to the fuel cell system. In still other embodiments, the water source for the membrane humidifier comprises both the electrochemical hydrogen pump anode exhaust flow and a water source external to the fuel cell system.

In some embodiments, the methods further comprise collecting leakage from a membrane/electrode assembly seal within an electrochemical hydrogen pump in a leakage collection plenum and providing the collected leakage to the electrochemical hydrogen pump anode exhaust flow.

As used herein, the term “fuel flow” is used to express the fuel introduced into the fuel cell. Typical fuels for fuel cell operation are fuels comprising hydrogen and carbon. Examples of typical fuels for fuel cell operation include but are not limited to hydrocarbons (including methane, ethane, propane, and natural gas), alcohols (including ethanol), and syngas derived from coal or natural gas reformation. Additionally, hydrogen may be introduced into the fuel flow to supplement typical fuels.

As used herein, the term “alcohol” is used to generally indicate an organic compound derivatized with a hydroxyl group. Examples of alcohols include, but are not limited to methanol, ethanol and isopropyl alcohol.

As used herein, the term “hydrogen” excludes hydrocarbon hydrogen atoms. For example, hydrogen includes molecular hydrogen (H₂).

### BRIEF DESCRIPTION OF THE DRAWINGS

FIGS. 1A and 1B show schematics of an exemplary SOFC system with a hydrogen separation device, an optional venturi and suction lines, an optional membrane humidifier, and optional hydrogen separation device radiative heater.

FIG. 2 shows a graph of current versus potential for electrochemical hydrogen pumps operated at fuel utilizations of 60%, 80%, 90%, 95%, and 99%.

FIG. 3 shows a schematic of an exemplary venturi that may be used in embodiments of the present invention.

FIG. 4 shows a schematic of an exemplary multi-member seal in a membrane/electrode assembly of an electrochemical hydrogen pump plumbed with a leakage collection plenum.

FIG. 5 shows a schematic of SOFC stack cathode exhaust being used to heat an electrochemical hydrogen pump according to one embodiment of the present invention.

### DETAILED DESCRIPTION OF THE INVENTION

During operation of a SOFC, a high rate of fuel recirculation is desirable to obtain a high overall fuel utilization, which results in a high system efficiency. At the same time, there is a need to supply the inlet hydrocarbon fuel with sufficient water to prevent coking during fuel reformation. To maximize cell voltage efficiency, the added water should be minimized to just above that required to prevent coking. However, anything less than 100% fuel utilization results in unreacted hydrogen being present in the fuel cell stack anode exhaust.

Fuel Recapture with Electrochemical Hydrogen Pump

It is well known that under normal operating conditions, the anode exhaust stream from a SOFC contains both water and unreacted fuel. It is also well known that a portion of the water-containing anode exhaust stream may be recirculated out of the anode exhaust stream into the anode inlet stream with a mechanical blower to contribute to the water required for coke-free fuel reforming. Without additional processing of the anode exhaust stream, such a configuration may be used to reach a system efficiency of about 85% to 90% fuel utilization.

Embodiments of the present invention utilize additional processing of the anode exhaust stream with a hydrogen separation device before recirculation into the anode inlet. The hydrogen separation device is used to enrich the recirculated portion of anode exhaust stream with hydrogen by electrochemically pumping most of the remaining about 10% to 15% of hydrogen out of the SOFC stack anode exhaust stream. After the anode exhaust stream has been processed with a hydrogen separation device, the recirculated portion of the anode exhaust stream is enriched with at least 50% of the unreacted fuel in the unprocessed anode exhaust stream. In preferred embodiments, the recirculated portion of the anode exhaust stream is enriched with at least 75% of the unreacted fuel remaining in the unprocessed anode exhaust stream; preferably at least 90%, preferably at least 95%, preferably about 95% to 99%. Thus, about 95% of the unreacted 10% to 15% of the initial hydrogen in the fuel inlet stream remaining in the unprocessed anode exhaust stream may be separated and returned as fuel to the SOFC stack anode inlet. The overall system efficiency of systems utilizing this arrangement may be improved by as much as 5% to 6%.

One hydrogen separation device that may be used in embodiments of the present invention is an electrochemical hydrogen pump, such as that described in U.S. published application 2003/0196893, incorporated herein in its entirety. Other suitable pumps may also be used.

For example, the electrochemical hydrogen pump may comprise any suitable proton exchange membrane device comprising a polymer electrolyte, and an anode and cathode located on either side of the electrolyte, which together comprise a membrane/electrode assembly (MEA). An electrochemical hydrogen pump of this type operates as follows. Within the MEA, a feed stream supplies a hydrogen-containing stream, such as a SOFC stack anode exhaust stream, to the anode, where it is electrochemically reacted to produce electrons, protons, and other reaction products. The protons transport through the electrolyte, which is proton conductive but substantially impermeable to reactant gas. The anode and cathode are connected to an electric circuit to create an electric potential between them and allow electric current to flow from one to the another. Protons that migrate through the electrolyte to the cathode combine with electrons to produce hydrogen gas. The gas exiting from the anode side of the electrochemical hydrogen pump has significantly diminished hydrogen content, but is still carbon dioxide and water rich.

This type of electrochemical hydrogen pump may be configured as a cascade pump. In a cascaded pump, several sets of cells are arranged in process fluid flow series so that the exhaust from one set of cells is used as an input for the next set of cells. In each set of two or more cells, at least two cells are arranged in parallel, such that the input stream is divided among the cells in the set. In other words, any one cell in one set is in process fluid flow series configuration with any one other cell in a different set, but all cells in each set are preferably in process fluid flow parallel configuration with respect to each other. The electrochemical hydrogen pump may contain two or more sets of cells, such as three to five sets of cells. Each set of cells may contain one or more cells, such as one to twenty cells. Preferably, but not necessarily, each set contains more cells than the set(s) located downstream from it. For example, in a case of a cascade pump having three sets of cells arranged in series, the cascade pump separates hydrogen from the exhaust stream in a three step sequence. First, a quantity (X) of fuel exhaust is provided simultaneously to a first set of cells having for example four cells, and a first portion (A) of hydrogen is separated. Second, a remaining quantity (X−A) of fuel exhaust is provided to a second set of cells having for example two cells, and a second portion (B) of hydrogen is separated. Third, a remaining quantity (X−A−B) of fuel exhaust is provided to the third set of cells having one cell, and a third portion (C) of hydrogen is separated. The separated hydrogen (A+B+C) is provided into conduit through the electrochemical hydrogen pump cathode output. The remaining portion of the fuel exhaust consisting essentially of carbon dioxide and water is provided into a conduit through the electrochemical hydrogen pump anode output. The total quantity of separated hydrogen (A+B+C) is at least at least 50% of the hydrogen contained in the quantity (X) of fuel exhaust provided to the electrochemical hydrogen pump. Preferably, the total quantity of separated hydrogen is at least 75%; preferably at least 90%, preferably at least 95%, preferably about 95% to 99%.

Preferably, an electrochemical hydrogen pump comprises a stack of carbon monoxide tolerant electrochemical cells, such as a stack of high-temperature, low-hydration ion exchange membrane cells. This type of cell includes a non-fluorinated ion exchange ionomer membrane, such as, for example, a polybenzimidazole (PBI) membrane. The membrane is doped with an acid, such as sulfuric or phosphoric acid. An example of such cell is disclosed in US published application US 2003/0196893, incorporated herein by reference in its entirety. These cells generally operate in a temperature range of above 100 to about 200 degrees Celsius. Thus, discussed in detail below, heat exchangers may be included in the SOFC system to preferably keep the anode exhaust stream at a temperature of about 120 to about 200 degrees Celsius, such as about 160 to about 190 degrees Celsius.

Operation of SOFC systems which incorporate an electrochemical hydrogen pump allows for SOFC fuel utilization rates approaching 100%. To reach such high SOFC fuel utilization rates, the electrochemical hydrogen pump must be operated in excess of 90% utilization, such as equal to or greater than 95% utilization. This means that at least 90%, preferably at least 95%, of hydrogen in the SOFC stack anode exhaust stream is separated and recycled. Under these conditions, the SOFC system may be operated with at least 96% fuel utilization, preferably at least 97% fuel utilization, preferably at least 98% fuel utilization, preferably about 99% fuel utilization.

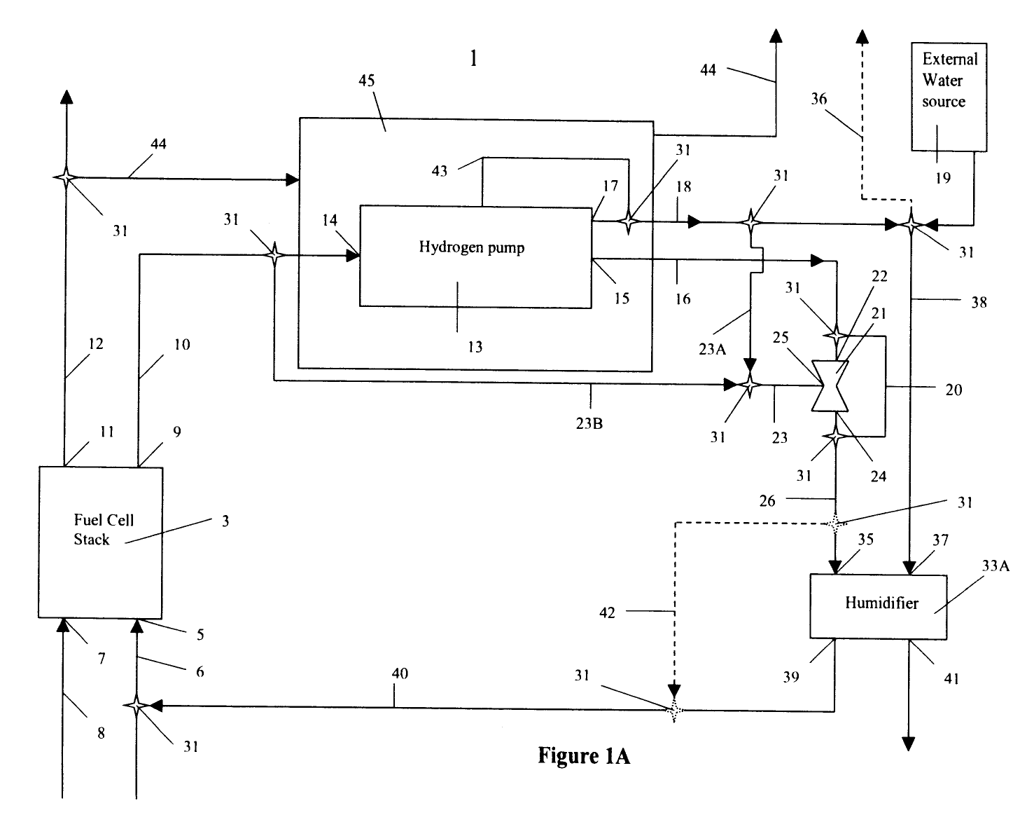

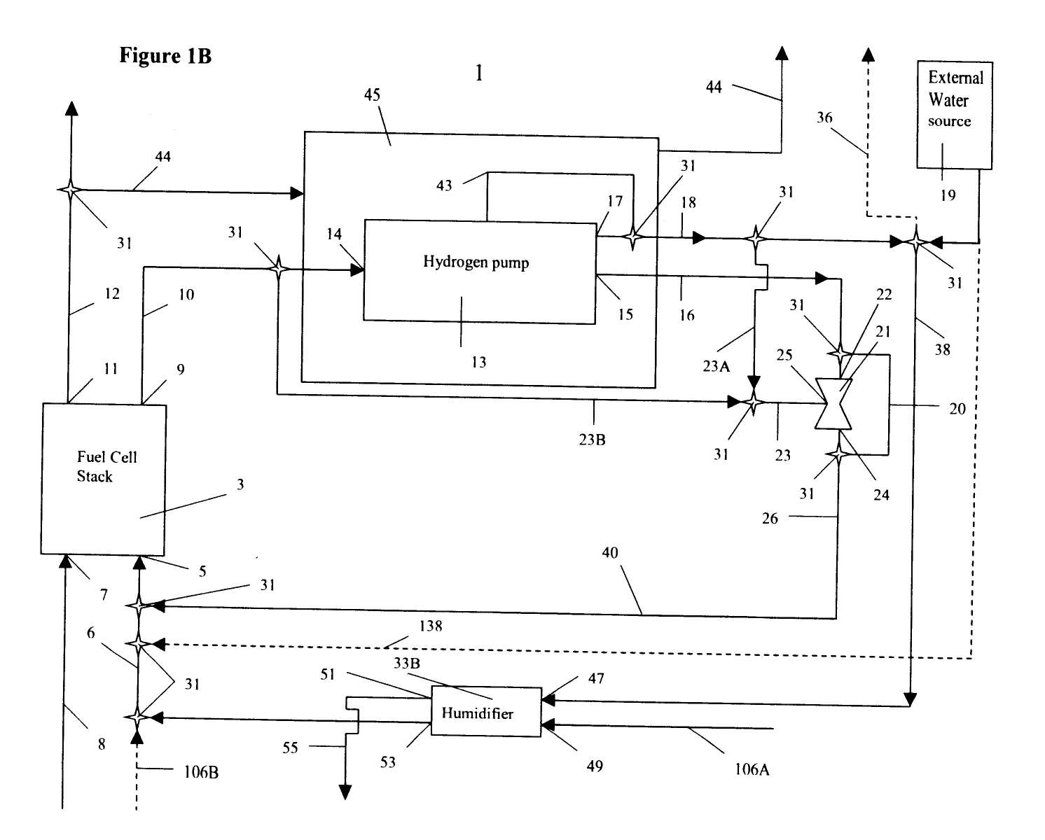

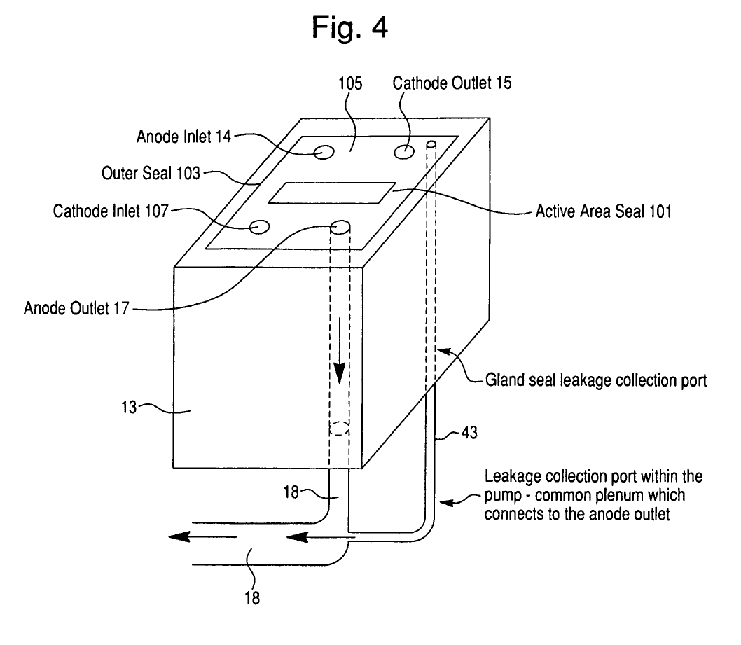

An exemplary fuel cell system 1 containing a fuel cell stack 3, electrochemical hydrogen pump 13, and several of the optional features described below is shown schematically in FIGS. 1A and 1B. The fuel cell system 1 preferably comprises a high temperature fuel cell system, such as a SOFC, SORFC, or molten carbonate fuel cell system, which comprises a plurality of fuel cell stacks. The fuel cell stack 3 includes a fuel (e.g. anode) inlet 5 connected to the fuel inlet conduit 6, an oxidizer (e.g. air) inlet 7 connected to an oxidizer inlet conduit 8, a fuel (e.g. anode) outlet 9 connected to a fuel exhaust conduit 10, and an oxidizer (i.e., cathode) outlet 11 connected to cathode exhaust conduit 12. The pump 13 comprises an anode inlet 14 fluidly connected to conduit 10, a cathode outlet 15 which provides a hydrogen rich stream into exhaust conduit 16 and an anode outlet 17 which provides a carbon dioxide and water rich stream to an anode exhaust conduit 18. The pump 13 may optionally comprise a cathode inlet 107 (shown in FIG. 4), which may also be operatively connected to the exhaust conduit 16. The hydrogen rich stream is ultimately recycled back into the anode inlet stream via conduit 40.

Anode Exhaust Monitoring with Electrochemical Hydrogen Pump

One of the benefits to operating the electrochemical hydrogen pump at a high fuel utilization is that the electrochemical characteristics of the electrochemical hydrogen pump (i.e., the current and potential) can be monitored to detect changes in the SOFC fuel inlet flow and control that flow with feedback to the fuel flow controller. To facilitate detection of these changes, the electrochemical hydrogen pump may be operated at approximately 95% utilization with a fixed current. In these embodiments, the pump potential (i.e., voltage) is monitored over time.

Observation of a decrease in the electrochemical hydrogen pump voltage indicates an increase in the anode hydrogen discharge. Such an increase is likely indicative of: a) a SOFC power reduction without a fuel flow reduction; b) an unintended fuel flow increase; and/or c) a composition change in the fuel inlet stream, such as natural gas.

Observation of an increase in the electrochemical hydrogen pump voltage indicates a decrease in the anode hydrogen discharge. Such a decrease is likely indicative of: a) a SOFC power increase without a fuel flow increase; b) an unintended fuel flow decrease; c) a composition change in the fuel inlet stream, such as natural gas; d) a fuel leakage from the system; and/or e) an unproductive anode fuel combustion.

In these embodiments, a control device, such as a generic or specialized computer or another suitable logic device, such as microprocessor or ASIC, is used to monitor the electrochemical hydrogen pump current and potential. In certain related embodiments, data generated by sensors capable of measuring electrochemical hydrogen pump current and potential may be accessible by the control device, such as the computer. Data from sensors may be transmitted to the computer either wirelessly or through wires.

In additional related embodiments, the control device, such as the computer, may be connected (wired or wirelessly) to a display apparatus, such as a display monitor, to display the data generated by the sensors. In these embodiments, the operator of a SOFC system can utilize the displayed output to determine necessary adjustments to fuel, oxidizing gas and/or water flows into the system and/or system power output so that the fuel utilization reaches and/or stays at or above a desired level.

In other related embodiments, the control device, such as the computer used to monitor the electrochemical hydrogen pump or another computer networked with the computer monitoring the electrochemical hydrogen pump, may also be used to automatically control the flow of fuel, oxidizing gas and/or water into the fuel cell system and/or system power output. In these embodiments, the computer can monitor the electrochemical hydrogen pump current and potential for deviations from a desired range to notify a user of possible problems with the SOFC operation via a visual, audible, or electronic alarm system. The computer may also be used to determine if adjustments to fuel, oxidizing gas and/or water flows into the system and/or system power output may be necessary so that the fuel efficiency reaches and/or stays at or above a preferred level.

For example, in the above embodiments the control computer used to monitor the electrochemical hydrogen pump may be connected to a flow controller, such as a computer controlled valve, or a power output controller, such as a power conditioning system, such that if the electrochemical hydrogen pump potential decreases while under a constant current, the fuel flow may be decreased, and/or the system power output may be increased. Conversely, if the electrochemical hydrogen pump potential increases while under a constant current, the fuel flow may be increased and/or the system power output may be decreased. The adjustment may be done manually by the operator or automatically by the control device.

An exemplary system with two SOFC modules of 24 cells were operated at a total of one kW and were combined with a four-cell electrochemical hydrogen pump operate at 66 amps to produce an exemplary SOFC system with anode exhaust hydrogen recovery and recycling. A series of tests were conducted whereby methane fuel utilization of the two SOFC modules was increased in small increments to 99%. At about 98% SOFC fuel utilization, the electrochemical hydrogen pump was operated such that about 90% of the hydrogen in the SOFC stack anode exhaust was separated and recycled. To reach about 99% SOFC fuel utilization, the electrochemical hydrogen pump was operated such that about 95% of the hydrogen in the SOFC stack anode exhaust was separated and recycled. This difference in the pump voltages between operation of the pump at 90% hydrogen recapture and 95% hydrogen recapture is easily discernable.

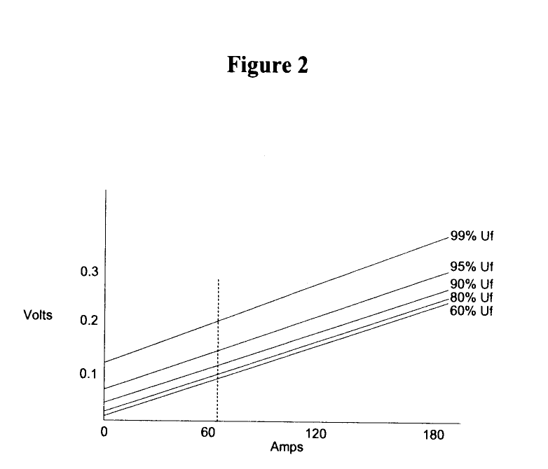

FIG. 2 shows the general characteristics of the 250 cm² active area hydrogen pump operating at various fuel utilizations. As demonstrated, electrochemical hydrogen pumps can reach very high utilizations, but very little cell voltage change is observed in the pump until the 90% recapture level is reached. The change in voltage only increases as the recapture level increases, and is relatively large between the 90% and the 95% levels.

Operating the electrochemical hydrogen pump in this system at 95% hydrogen recapture at a constant current provided an instant signature for even minor changes in the anode hydrogen discharge rate, seen as an increase or decrease in the pump voltage. This allowed for rapid flow adjustment to maintain a near constant hydrogen flow to the hydrogen pump.

Thus, SOFC systems operating with recycled hydrogen recaptured with an electrochemical hydrogen pump offer several advantages to systems lacking the pump. First, the electrochemical characteristics of the pump allow for monitoring and control of fuel flow to reach and/or maintain a SOFC fuel utilization at or near 99%. Second, monitoring the electrochemical characteristics of the pump provides near instantaneous notification of fuel leakage and/or unproductive fuel combustion. Finally, monitoring the pump also provides the ability to detect even minor changes in the composition of the fuel source, which allows for adjustment of the water flow to optimize fuel utilization.

Water Recapture with Electrochemical Hydrogen Pump

During anode exhaust processing with an electrochemical hydrogen pump, such as a pump described above, water is also transferred from the pump anode to the pump cathode during the electrochemical hydrogen pumping process. The water transfer rate can be controlled independently of the hydrogen pumping rate by controlling the electrochemical hydrogen pump fuel utilization (i.e., by controlling the hydrogen fuel utilization rate within the pump anode). The higher the electrochemical hydrogen pump fuel utilization rate, the higher the water transfer rate. The water recirculation rate is easily determined by pump utilization rate and hydrogen pump rate and thus independent water flow measurement is not required.

Thus in some embodiments, the amounts of water and hydrogen being recirculated in a SOFC are independently controlled by an electrochemical hydrogen pump, eliminating the need for a mechanical anode recycle blower in the system, which reduces system costs and increase system efficiency and reliability.

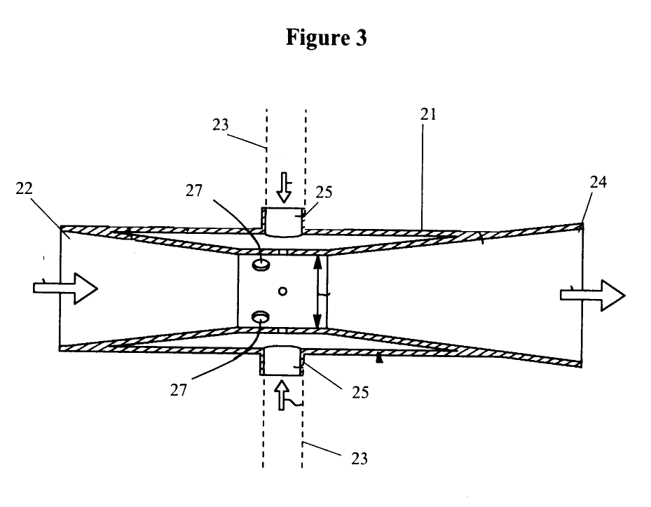

In some embodiments, a SOFC system may include a venturi positioned between the hydrogen-rich electrochemical pump cathode outlet 15 and the SOFC stack anode inlet 5. The exemplary system 1 shown in FIGS. 1A and 1B has such a venturi 21. In these embodiments, the venturi 21 may be designed with a pressure drop on the order of about 100 PSI, with a suction line 23 plumbed to an inlet 25 at the low pressure throat region of the venturi which comprises an annular region which is separated from the main passage of the venturi by openings 27. One type of venturi for use in these embodiments may be of the type disclosed in U.S. patent application Ser. No. 11/703,152 (filed Feb. 7, 2007), hereby incorporated by reference in its entirety. An example of such a venturi is shown in FIG. 3.

In some embodiments, the suction line 23 is connected to the carbon dioxide and water-rich electrochemical pump anode outlet conduit 18 via conduit 23A, thus providing a source of water for recycling into the SOFC stack anode inlet 5. Water flow from suction line 23A may be independently controlled with a flow controller to optimize water flow into the SOFC.

In some embodiments, the suction line 23 is connected to the SOFC stack anode exhaust conduit 10 upstream of the electrochemical hydrogen pump 13 via conduit 23B, thus providing a flow from the suction line 23 that is more hydrogen rich than a flow from the electrochemical hydrogen pump anode outlet 15. Flow from suction line 23B may be independently controlled with a flow controller to optimize water flow into the SOFC.

In embodiments that incorporate a venturi 21 and at least one of suction lines 23A and 23B, valves such as solenoid or motorized valves may be placed in parallel with the suction line, such that the suction line flow can be controlled either manually or via computer. In related embodiments, multi-way valves 31, such as 2-way or 3-way valves, may be used to allow for controlled mixing of flows from the electrochemical hydrogen pump anode exhaust conduit 18 and the SOFC stack anode exhaust conduit 10 from upstream of the electrochemical hydrogen pump 13. One skilled in the art will recognize that a variety of valve types and configurations may be used to accomplish the controlled mixing.

Controlled mixing of the flows entering the venturi 21 via the suction line 23 is useful to adjust the quantity and composition of the recycled gas flow for optimization depending on fuel type. For example, with methane as the SOFC fuel, the suction line 23 may be closed entirely, with the electrochemical hydrogen pump cathode exhaust passing through the venturi 21 before being provided to the SOFC stack anode inlet 5. However, with ethane as the SOFC fuel, the suction line 23 may be opened to allow water-rich electrochemical hydrogen pump anode exhaust flow from conduit 23A, thus providing a higher steam-to-carbon ratio at the SOFC stack anode inlet 5. Thus, line 23 may be closed when a low carbon fuel is used and opened when the system switches to a higher carbon fuel.

In some embodiments, a portion or all of the electrochemical hydrogen pump cathode flow may be routed around the venturi 21 via a bypass conduit 20 in instances when the full pressure drop caused by the venturi 21 is not desired. As above, solenoid or motorized valves may be placed in parallel with the bypass conduit 20, such that the bypass conduit 20 flow can be controlled either manually or via computer. In related embodiments, multi-way valves 31, such as 2-way or 3-way valves, may be used to allow for a portion of the electrochemical hydrogen pump cathode exhaust flow to be diverted through bypass conduit 20, while still allowing a portion of the flow to continue through the venturi 21. One skilled in the art will recognize that a variety of valve types and configurations may be used to accomplish controlled mixing of bypass conduit 20 flow and the flow exiting the venturi 21 at venturi outlet 24 via conduit 26.

### Combined Water-Gas Shift Reactor and Electrochemical Hydrogen Pump

The water-gas shift reaction (or WGS reaction) is a chemical reaction in which carbon monoxide reacts with water to form carbon dioxide and hydrogen. Suitable catalysts for this reaction are widely known and are often used in conjunction with steam reforming of methane or other hydrocarbons, such as for example an iron oxide or a chromium promoted iron oxide catalyst.

In some embodiments, a WGS reaction catalyst is incorporated within an electrochemical hydrogen pump 13 so that carbon monoxide in the presence of water in the SOFC stack anode exhaust flow may be converted to hydrogen and carbon dioxide (as well as residual water), thus increasing the amount of hydrogen available to be separated from the anode exhaust provided from outlet 9 and recycled into the SOFC stack anode inlet 5.

In some embodiments, the WGS reaction catalyst is incorporated into or on a proton exchange membrane so that the WGS reaction takes place concurrently with electrochemical hydrogen pumping at the proton exchange membrane. In these embodiments, the WGS reaction catalyst is preferably located on the anode side of the proton exchange membrane.

In alternative embodiments, the WGS reaction catalyst is mounted inside the electrochemical hydrogen pump 13 on a mesh matrix positioned upstream of proton exchange membrane.

Incorporation of the WGS reaction catalyst into the electrochemical hydrogen pump 13 has the benefit of improving WGS reaction performance because before the WGS reaction can become equilibrium limited, hydrogen is moved away from the WGS reaction catalyst, allowing further WGS reaction. An added benefit of the combination of the WGS reaction catalyst and the electrochemical hydrogen pump 13 is elimination of the need for a separate WGS reactor, thus simplifying the SOFC system and potentially reducing system cost.

### Membrane Humidifier and Electrochemical Hydrogen Pump

Incorporation of a membrane humidifier into a SOFC system is well known in the art. Typical fuel humidifiers useful for SOFC operation may comprise a polymeric membrane humidifier, such as a Nafion® membrane humidifier, an enthalpy wheel or a plurality of water adsorbent beds, as described for example in U.S. Pat. No. 6,106,964 and in U.S. application Ser. No. 10/368,425, which published as U.S. Published Application Number 2003/0162067, all of which are incorporated herein by reference in their entirety. For example, one suitable type of humidifier comprises a water vapor and enthalpy transfer Nafion® based, water permeable membrane available from Perma Pure LLC. In operation, the humidifier passively transfers water vapor and enthalpy from the fuel exhaust stream into the fuel inlet stream to provide a desired steam to carbon ratio in the fuel inlet stream. The fuel inlet stream dew point temperature may be raised to about 80-90° Celsius in the humidifier.

In some embodiments shown in FIG. 1A, the SOFC system 1 further comprises a fuel humidifier 33A having a first inlet 35 operatively connected to the hydrogen-rich electrochemical hydrogen pump cathode exhaust flow via conduit 16, a second inlet 37 operatively connected to the water-rich electrochemical hydrogen pump anode exhaust flow via conduit 38, a first outlet 39 operatively connected to the SOFC stack anode inlet 5 via conduit 40, and a purge outlet 41. In this configuration, the fuel humidifier 33A is preferably a membrane humidifier that is capable of extracting water in a gas-to-gas arrangement. Thus, in operation, the fuel humidifier humidifies the recycled hydrogen in the electrochemical hydrogen pump cathode flow using water vapor contained in electrochemical hydrogen pump anode flow. In some embodiments, the humidifier 33A is bypassed via bypass conduit 42. Access to the bypass conduit may be controlled by a valve 31.

In alternative embodiments, the humidifier 33A may be arranged to transfer water to the recycled hydrogen in the electrochemical hydrogen pump cathode flow from an external water source 19 in addition to or instead of the water from the pump 13 anode exhaust flow. This is accomplished by using a fuel humidifier 33A having a first inlet 35 operatively connected to the hydrogen-rich electrochemical hydrogen pump cathode exhaust flow via conduit 16, a second inlet 37 operatively connected to the external water source 19 such as the local water supply (in addition to or instead of pump 13 anode exhaust flow), a first outlet 39 operatively connected to the SOFC stack anode inlet 5 via conduit 40, and a purge outlet 41. This arrangement may be preferred for operation of a SOFC with heavy hydrocarbon fuels, because operation of a SOFC with such fuels often requires very high steam to carbon ratios in the SOFC stack anode inlet stream.

In yet further alternative embodiments shown in FIG. 1B, the fuel humidifier may be used to humidify the fuel inlet stream directly. In these alternative embodiments, the fuel humidifier may not be used to treat the recycled hydrogen flow and the humidifier is not located on conduits 26 and 40. Instead, the fuel humidifier 33B is located on the fuel inlet conduit 6 either upstream or down stream of the mixing point 31 where the recycle conduit 40 joins the fuel inlet conduit 6 to humidify the dry fuel inlet stream using water vapor from pump 13 and/or from water source 19 passing through conduit 38.

The humidifier 33B has a first inlet 49 operatively connected to the first inlet portion 106A of the fuel inlet conduit 6, a second inlet 47 operatively connected to the water-rich electrochemical hydrogen pump 13 anode exhaust flow and/or water from an external water source 19 provided via conduit 38, a first outlet 53 operatively connected to the SOFC stack anode inlet 5 via conduit 6, and a water vapor purge outlet 51 connected to a purge conduit 55. If desired, an optional second inlet portion 106B of the fuel inlet conduit 6 may bypass the humidifier and provide fuel directly into the anode inlet 5.

Furthermore, the external water source 19 may contain an evaporator (i.e., a steam generator). In this case, the water source 19 may be connected to conduit 6 (upstream or downstream of the mixing point 31 at the junction of conduits 6 and 40), including being connected to inlet portions 106A and/or 106B of conduit 6, and/or being connected to conduit 40 and/or being connected directly to the mixing point 31 at the junction of conduits 6 and 40, instead of or in addition to being connected to conduit 38. An example of such a connection is shown by the dashed line for optional conduit 138 in FIG. 1B, where the water source 19 is connected to conduit 6 upstream from conduit 40 but down stream from humidifier 33B.

### Cell Seal Leakage Collection

In an electrochemical hydrogen pump comprising at least one MEA, one or more seals are necessary within each MEA to isolate one side of the membrane from the other.

In some embodiments, one or more of the seals within in the MEA are multi-member seals. As used herein, a “multi-member seal” is a seal that comprises a plurality of seal members. It is not necessary for each member of the multi-member seal to have a distinct composition. In multi-member seals, any two seal members may be positioned so that they are in contact (i.e., they abut), or may be positioned so that a gap is defined between the two members 101 and 103.

In related embodiments where one or more multi-member seals are positioned in the MEA such that a gap is defined between two seal members, one or more of the MEA surfaces in contact with the multi-member seal may have a leakage collection plenum 105 defined by the gap between the members of the members of the multi-member seal. Thus, if there is leakage from the inner member 101 (i.e., active area seal) of the multi-member seal, the leakage collects in the leakage collection plenum 105. In some embodiments, this leakage collection plenum is plumbed via collection conduit 43 to connect to the electrochemical hydrogen pump anode exhaust flow in conduit 18 and drawn off (shown in FIGS. 1A and 1B). Collection conduit 43 may contain a gland type seal to prevent backflow. A schematic of an exemplary multi-member seal and leakage collection plenum system is shown in FIG. 4.

### Electrochemical Hydrogen Pump Heat Exchange

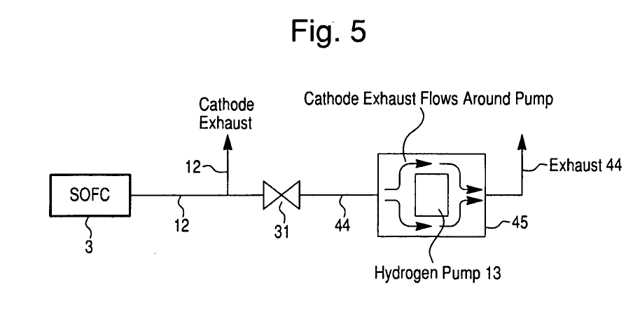

As indicated above, preferred electrochemical hydrogen pumps generally operate in a temperature range of above 100 to about 200 degrees Celsius. In some embodiments, the SOFC stack cathode exhaust is utilized to heat the electrochemical hydrogen pump to heat it to and/or maintain a preferred operation temperature. This may be accomplished by routing some or all of the SOFC stack cathode exhaust flow in conduit 12 via conduit 44 to pass around and heat the electrochemical hydrogen pump 13 (shown in FIGS. 1 and 5 as chamber 45) via convective and/or conductive heat transfer. Electric heaters may be utilized during start-up if it is desirable to have the electrochemical hydrogen pump in operation early in the start-up of a SOFC system; however, once the SOFC reaches normal operating temperatures electric heaters may not be necessary to maintain preferred operational temperatures. A valve 31 may direct SOFC stack cathode exhaust flow to chamber 45 or out to exhaust.

In alternative embodiments, the SOFC system may comprise a catalytic reactor, such as a catalytic partial oxidation (CPOx) reactor. This reactor may be used to pre-heat the SOFC anode inlet flow. In some of these embodiments, some or all of the pre-heated SOFC anode inlet flow may be used to pre-heat the electrochemical hydrogen pump. At low power, the reactor heats the SOFC stack and helps to reform the anode (i.e., fuel) inlet flow. At full power, the pump may be heated by the SOFC stack or the pump may be sized so that the pump is net heat producing (e.g., a pump which runs at a higher current density and slightly lower efficiency) and heat from the SOFC stack, such as heat from the SOFC stack cathode exhaust, is not used to heat the pump.

In alternative embodiments, a high temperature hydrogen pump, such as a solid state proton conductor type pump, may be used. In some of these embodiments, the SOFC cathode exhaust may be flowed around the pump to remove (instead of add) excess heat from the high temperature hydrogen pump. Thus, the pump exchanges heat (i.e., either removes or receives heat) with the SOFC stack cathode exhaust. In other of these embodiments, the high temperature hydrogen pump (e.g., a pump that does not have to be preheated to above 100 C before operation like the PBI membrane pump) may be used to pre-heat the SOFC cathode inlet flow (i.e., the air inlet stream). In other words, the air inlet stream exchanges heat with the high temperature pump and/or a pump exhaust stream using a heat exchanger or another heat exchange configuration.

The foregoing description of the invention has been presented for purposes of illustration and description. The methods and devices illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the invention embodied therein herein disclosed may be resorted to by those skilled in the art, and that such modifications and variations are considered to be within the scope of this invention. It is intended that the scope of the invention be defined by the claims appended hereto, and their equivalents.

What is claimed is:

1. A method of operating a fuel cell system comprising a fuel cell stack and an electrochemical hydrogen pump, comprising:
a. providing at least a portion of the fuel cell stack anode exhaust to the electrochemical hydrogen pump;
b. separating at least a portion of hydrogen contained in the fuel cell stack anode exhaust stream with the electrochemical hydrogen pump;
c. providing at least a portion of the separated hydrogen into the fuel cell stack anode inlet;
d. monitoring a potential of the electrochemical hydrogen pump; and
e. adjusting a flow of one or more of the fuel cell stack input streams or power output of the system based on the monitoring.

2. The method of claim 1, wherein the electrochemical hydrogen pump comprises a proton exchange membrane or a high temperature proton exchange membrane based on a polybenzimidazole (PBI) membrane and is operated at a steady current.

3. The method of claim 1, wherein the electrochemical hydrogen pump is operated such that 90% or more of the hydrogen in the fuel cell stack anode exhaust is pumped to a cathode outlet of the electrochemical hydrogen pump.

4. The method of claim 1, wherein the step of adjusting the flow of one or more fuel cell stack input gases comprises increasing flow of fuel inlet gas to the fuel cell stack upon detection of an increase in the potential of the electrochemical hydrogen pump, or decreasing flow of fuel inlet gas to the fuel cell stack upon detection of a decrease in the potential of the electrochemical hydrogen pump.

5. The method of claim 1, wherein the step of adjusting the power output of the system comprises increasing a fuel cell stack power output based on detection of a decrease in potential of the electrochemical hydrogen pump, or decreasing a fuel cell stack power output based on detection of an increase in the electrochemical hydrogen pump potential.

6. The method of claim 1, wherein operation of the electrochemical hydrogen pump results in transfer of water from the fuel cell stack anode exhaust flow to the electrochemical hydrogen pump cathode outlet flow.

7. The method of claim 1, wherein the step of providing at least a portion of the separated hydrogen comprises providing at least a portion of the electrochemical hydrogen pump cathode outlet flow into the fuel cell stack anode inlet.

8. The method of claim 1, further comprising providing at least a portion of the fuel cell stack anode exhaust flow to the fuel cell stack anode inlet while bypassing the electrochemical hydrogen pump.

9. The method of claim 1, wherein the electrochemical hydrogen pump contains a water-gas shift (WGS) catalyst located upstream of the proton exchange membrane or incorporated into or on the proton exchange membrane.

10. The method of claim 1, further comprising humidifying the separated hydrogen with a membrane humidifier prior to providing the separated hydrogen into the fuel cell stack anode inlet; wherein the membrane humidifier comprises a first inlet operatively connected to the electrochemical hydrogen pump cathode outlet, a second inlet operably connected to one or more of the electrochemical hydrogen pump anode exhaust and an external water source, and a first outlet operatively connected to the fuel cell stack anode inlet.

11. The method of claim 1, further comprising collecting fuel cell stack anode exhaust flow leakage from a leakage collection plenum in the electrochemical hydrogen pump and providing the leakage to the electrochemical hydrogen pump anode exhaust.

12. The method of claim 1, further comprising using at least a portion of the fuel cell stack cathode exhaust to heat the electrochemical hydrogen pump.

13. A fuel cell system comprising:
a. a fuel cell stack, comprising:
a plurality of fuel cells;
a plurality of interconnects;
an anode inlet;
a cathode inlet;
an anode exhaust outlet; and
a cathode exhaust outlet;
b. an electrochemical hydrogen pump, comprising:
an anode;
a cathode;
a proton exchange membrane;
an inlet;
an anode exhaust outlet; and
a cathode exhaust outlet; and
c. at least one control device which adjusts at least one of the flow rate of one or more fuel cell input streams and a power output of a fuel cell based on a detected potential of the electrochemical hydrogen pump;
wherein the fuel cell stack anode exhaust is operatively connected to the electrochemical hydrogen pump inlet, and the electrochemical hydrogen pump cathode outlet is operatively connected to the fuel cell stack anode inlet.

14. The fuel cell system of claim 13, wherein adjusting the flow of one or more fuel cell stack input gases comprises increasing flow of fuel inlet gas to the fuel cell stack upon detection of an increase in the potential of the electrochemical hydrogen pump, or decreasing flow of fuel inlet gas to the fuel cell stack upon detection of a decrease in the potential of the electrochemical hydrogen pump.

15. The fuel cell system of claim 13, wherein adjusting the power output of the fuel cell system based on a detected potential of the electrochemical hydrogen pump comprises increasing a fuel cell stack power output based on detection of a decrease in potential of the electrochemical hydrogen pump, or decreasing a fuel cell stack power output based on detection of an increase in the electrochemical hydrogen pump potential.

16. The fuel cell system of claim 13, wherein both the flow of one or more fuel cell stack input streams and the power output of a fuel cell stack are adjusted based on a detected potential of the electrochemical hydrogen pump.

17. The fuel cell system of claim 13, further comprising a venturi located between the electrochemical hydrogen pump anode exhaust outlet and the fuel cell stack anode inlet; wherein a downstream flow of the venturi is at a lower pressure than an upstream flow.

18. The fuel cell system of claim 17, further comprising a suction line operatively connected to a low pressure throat of the venturi; wherein the suction line is operatively connected to one or more of the fuel cell stack anode exhaust conduit upstream of the electrochemical hydrogen pump and the electrochemical hydrogen pump anode exhaust conduit.

19. The fuel cell system of claim 18, further comprising a venturi bypass conduit.

20. The fuel cell system of claim 13, further comprising a water-gas shift reaction catalyst which is integrated into or on the proton exchange membrane or located within the electrochemical hydrogen pump upstream of the proton exchange membrane.

21. The fuel cell system of claim 13, further comprising a membrane humidifier; wherein the anode exhaust conduit of the fuel cell stack is operatively connected to the electrochemical hydrogen pump inlet, and the electrochemical hydrogen pump cathode outlet, membrane humidifier, and fuel cell stack anode inlet are operatively connected such that the electrochemical hydrogen pump cathode outlet flow is humidified prior to being introduced to the fuel cell stack anode inlet.

22. The fuel cell system of claim 21, wherein the source of water for the membrane humidifier comprises the electrochemical hydrogen pump anode outlet flow.

23. The fuel cell system of claim 21, wherein the source of water for the membrane humidifier comprises a source external to the fuel cell system.

24. The fuel cell system of claim 13, wherein the electrochemical hydrogen pump further comprises a membrane/electrode assembly seal separating the proton exchange membrane from an anode or cathode; and leakage from the membrane/electrode assembly seal is collected in a plenum that is operatively connected to the electrochemical hydrogen pump anode outlet.

25. The fuel cell system of claim 13, further comprising a fuel cell stack cathode exhaust conduit that provides the fuel cell stack cathode exhaust to exchange heat with the electrochemical hydrogen pump.

26. A fuel cell system comprising:
a. a fuel cell stack, comprising:
a plurality of fuel cells;
a plurality of interconnects;
an anode inlet;
a cathode inlet;
an anode exhaust outlet; and
a cathode exhaust outlet;
b. an electrochemical hydrogen pump, comprising:
an anode;
a cathode;
a proton exchange membrane;
an inlet;
an anode exhaust outlet; and
a cathode exhaust outlet; and
c. means for adjusting at least one of the flow rate of one or more fuel cell input streams and a power output of a fuel cell based on a detected potential of the electrochemical hydrogen pump;
wherein the fuel cell stack anode exhaust conduit is operatively connected to the electrochemical hydrogen pump inlet, and the electrochemical hydrogen pump cathode outlet is operatively connected to the fuel cell stack anode inlet.

27. A method of operating a fuel cell system comprising a fuel cell stack and an electrochemical hydrogen pump, comprising:
a. providing at least a portion of the fuel cell stack anode exhaust to the electrochemical hydrogen pump;
b. transferring at least a portion of hydrogen and water contained in the fuel cell stack anode exhaust stream from the electrochemical hydrogen pump anode to the electrochemical hydrogen pump cathode;
c. providing at least a portion of the separated hydrogen and water into the fuel cell stack anode inlet;
wherein the transfer of hydrogen and the transfer of water from the electrochemical hydrogen pump anode to electrochemical hydrogen pump cathode are independently controlled by controlling fuel utilization rate at the electrochemical hydrogen pump anode.

28. The method of claim 27, further comprising providing at least a portion of electrochemical hydrogen pump cathode exhaust flow to a venturi upstream of the fuel cell stack anode inlet; wherein the flow upstream of the venturi is at a higher pressure than the flow downstream of the venturi.

29. The method of claim 28, further comprising providing at least a portion of electrochemical hydrogen pump cathode exhaust flow to a venturi bypass conduit which bypasses the venturi.

30. The method of claim 28, further comprising providing a portion of one or more of the electrochemical hydrogen pump anode exhaust flow and the fuel cell stack anode exhaust to a suction line operatively connected to a low pressure throat of the venturi.

31. The method of claim 30, further comprising adjusting a portion of one or more of the electrochemical hydrogen pump anode exhaust flow and the fuel cell stack anode exhaust provided to the suction line based on a change in the composition of fuel used in the fuel cell stack.

32. The method of claim 27, further comprising providing at least a portion of the fuel cell stack cathode exhaust to the electrochemical hydrogen pump so that the fuel cell stack cathode exhaust and the electrochemical hydrogen pump exchange heat.

33. The method of claim 27, wherein a water-gas shift reaction catalyst is integrated into or on a proton exchange membrane of the electrochemical hydrogen pump or located within the electrochemical hydrogen pump upstream of a proton exchange membrane.

34. The method of claim 27, further comprising humidifying the fuel cell stack anode inlet flow or the electrochemical hydrogen pump cathode exhaust flow with a membrane humidifier.

35. The method of claim 34, wherein the water source for the membrane humidifier comprises the electrochemical hydrogen pump anode exhaust flow.

36. The method of claim 34, wherein the water source for the membrane humidifier comprises a water source external to the fuel cell system.

37. The method of claim 27, further comprising collecting leakage from a membrane/electrode assembly seal within an electrochemical hydrogen pump in a leakage collection plenum and providing the collected leakage to the electrochemical hydrogen pump anode exhaust flow.
